(19) United States
(12) Patent Application Publication
(10) Pub. No.: US 2012/0067178 A1
(43) Pub. Date: Mar. 22, 2012

(54) ELECTRICAL TORSION WRENCH

(75) Inventor: Kuang-Hsin Huang, TAICHUNG CITY (TW)

(73) Assignee: TAKEN ETORQUE TECHNOLOGY CO., LTD., TAICHUNG CITY (TW)

(21) Appl. No.: 12/885,541

(22) Filed: Sep. 19, 2010

(51) Int. Cl. B25B 23/144

(52) U.S. Cl. 81/479

(57) ABSTRACT

An electrical torsion wrench includes a shank, an operational head and a handle respectively mounted to two opposite ends of the shank. The handle has a first abutment formed on a distal side and radially corresponding to an axis of the shank. A stick perpendicular extends from the first abutment. An electrical displayer is rotatably sleeved on the shank and axially adjacent to the handle for the operator to easily and clear read the operating torsion value in different visual angles. The electrical displayer has a second abutment formed on a distal side thereof and abutting against the first abutment. A curved groove is laterally defined in the second abutment for receiving the stick such that the rotary range of the electrical displayer is limited.

### BACKGROUND OF THE INVENTION

1. Field of the Invention

The present invention relates to a wrench, and more particularly to an electrical torsion wrench that has an adjustable visual angle for operator to easily read the operated torsion value.

2. Description of Related Art

A conventional electrical torsion wrench (80) in accordance with the prior art shown in FIG. 6 comprises an operational head (81). A shank (82) and a handle (83) sequentially and co-axially extending from the operational head (81). An electrical display (84) is securely sleeved on the shank (82) near the handle (83). The electrical display (84) has a window (841) disposed thereon for showing the operating torsion value.

However, the electrical display (84) is stable relative to the shank (82) such that the operator can not clearly read the number displayed on the window (841) in a great visual angle. It needs to be advantageously altered.

The present invention has arisen to mitigate and/or obviate the disadvantages of the conventional electrical torsion wrench.

### SUMMARY OF THE INVENTION

The main objective of the present invention is to provide an improved electrical torsion wrench that has an adjustable visual angle for operator to easily read the operated torsion value.

To achieve the objective, the electrical torsion wrench in accordance with the present invention comprises a shank, an operational head and a handle respectively mounted to two opposite ends of the shank. The handle has a first abutment formed on a distal side and radially corresponding to an axis of the shank. A stick perpendicular extends from the first abutment. An electrical displayer is rotatably sleeved on the shank and axially adjacent to the handle for the operator to easily and clear read the operating torsion value in different visual angles. The electrical displayer has a second abutment formed on a distal side thereof and abutting against the first abutment. A curved groove is laterally defined in the second abutment for receiving the stick such that the rotary range of the electrical displayer is limited.

The screen of the electrical displayer is parallel to the workpiece when the work piece is lower than the horizontal visual angle of the operator. The electrical displayer is turned toward the user's eye's for easily read the operating torsion value when the horizontal height of the workpiece approaches to the horizontal visual angle of the operator. Consequently, the operator can easily and clearly read the operating torsion value in different operational angle due to the rotary electrical displayer.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an electrical torsion wrench in accordance with the present invention;

FIG. 2 is a partially exploded perspective view of the electrical torsion wrench in FIG. 1;

FIG. 3 is a partially cross-sectional view of the electrical torsion wrench in FIG. 1;

FIG. 4 is a first operational view of the electrical torsion wrench in accordance with the present invention;

FIG. 5 is a second operational view of the electrical torsion wrench in accordance with the present invention; and

FIG. 6 is a perspective view of a conventional electrical torsion wrench in accordance with the prior art.

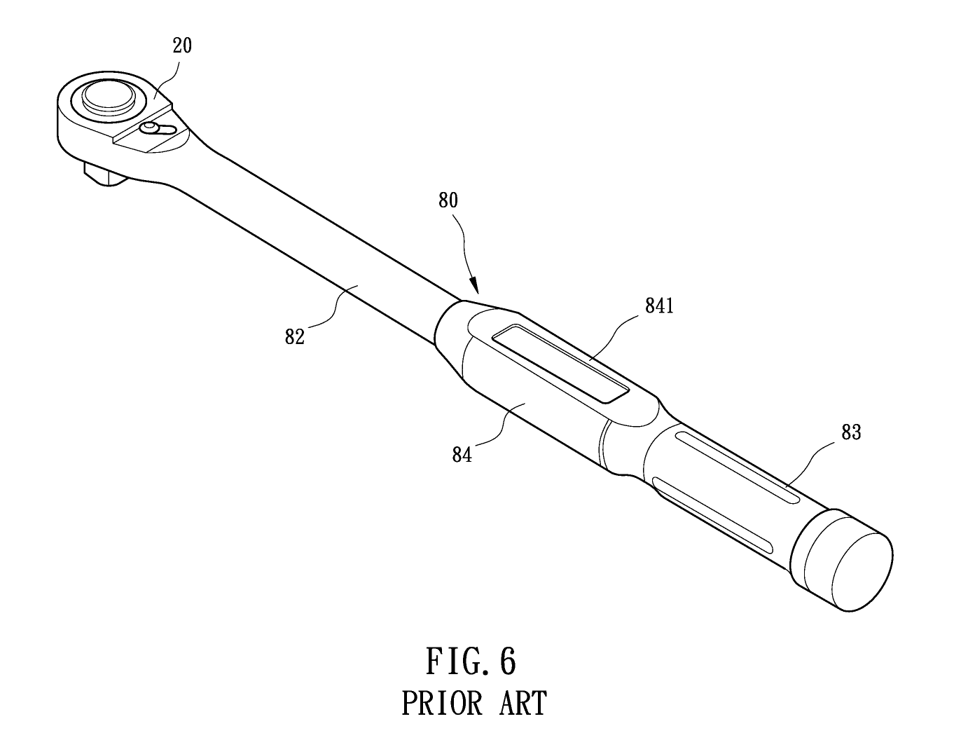

### DETAILED DESCRIPTION OF THE INVENTION

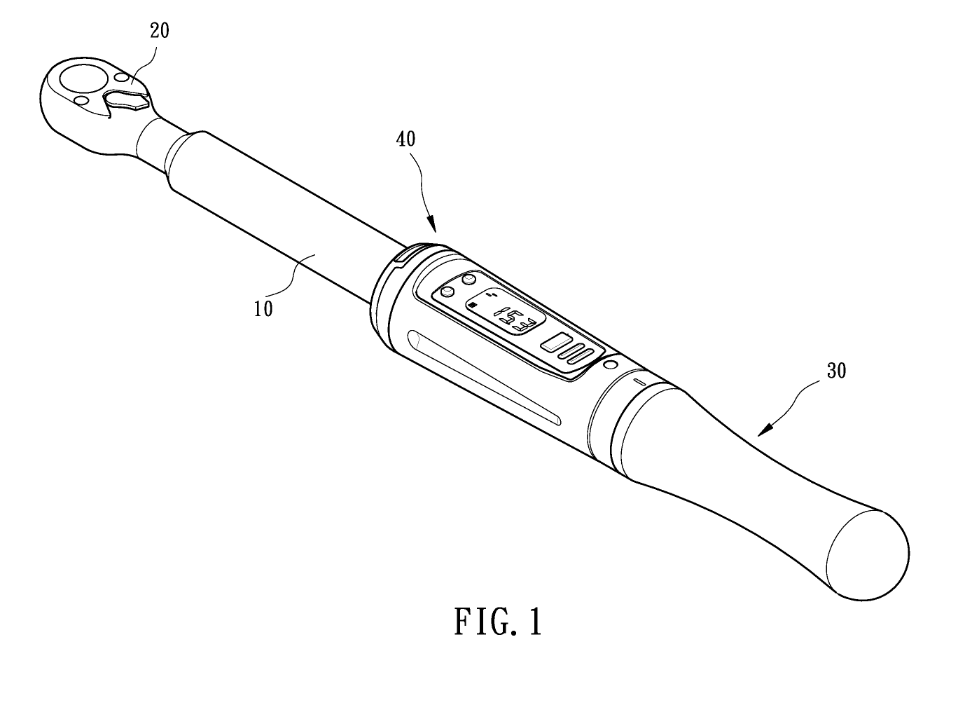

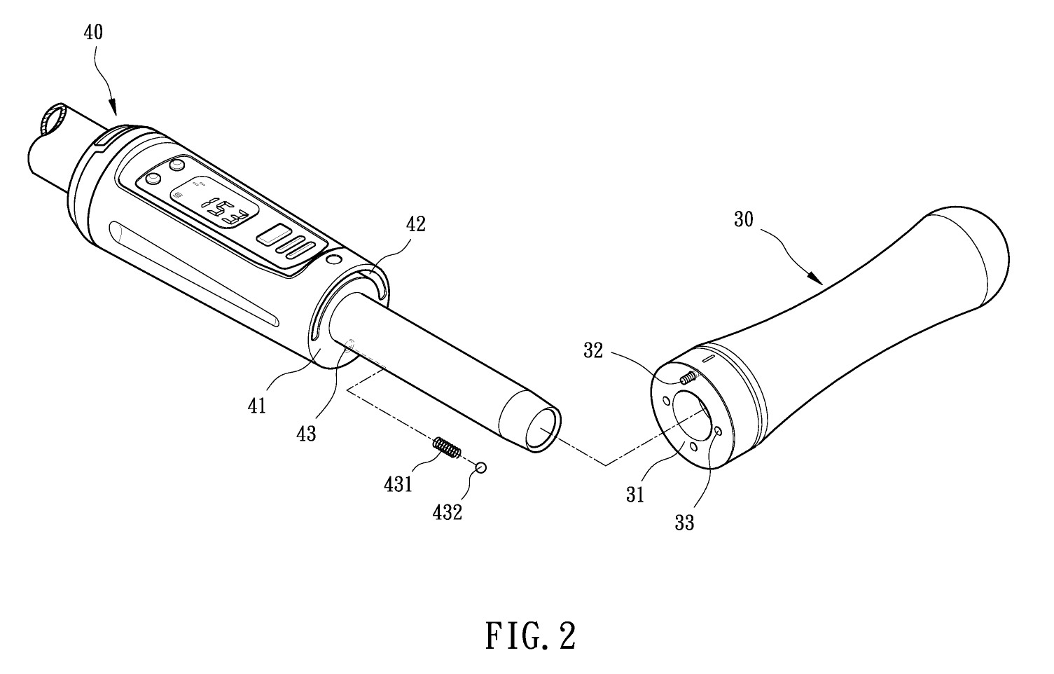

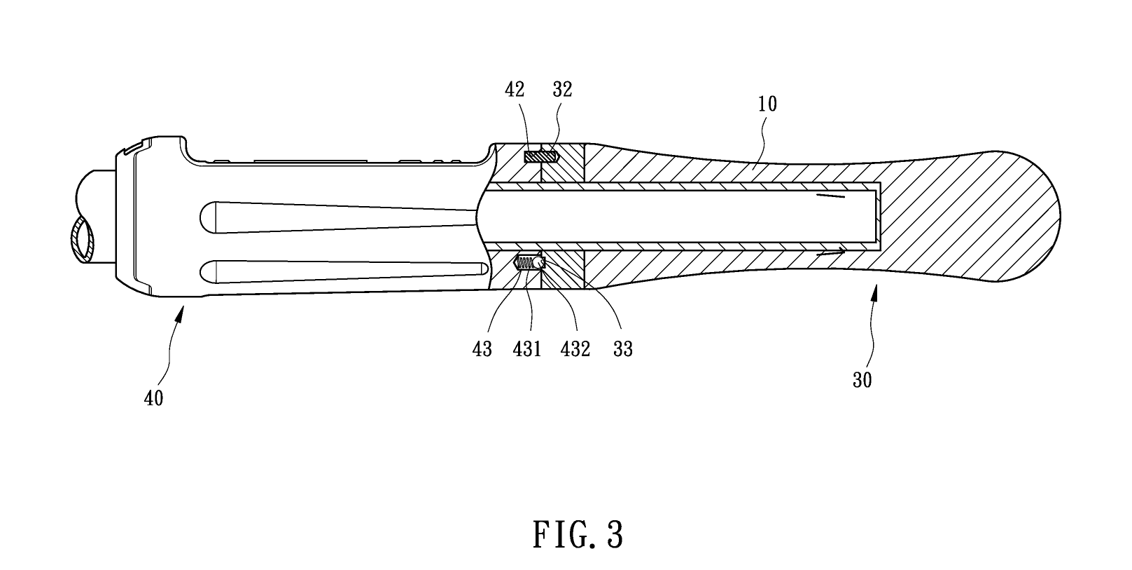

Referring to the drawings and initially to FIGS. 1-3, an electrical torsion wrench in accordance with the present invention comprises shank (10), an operational head (20) and a handle (30) respectively co-axially mounted to two opposite ends of the shank (10), wherein the operational head (20) and the handle (30) is not rotary relative to the shank (10). An electrical displayer (40) is rotatably sleeved on the shank (10) and axially adjacent to the handle (30) for operator to easily and clearly read the operating torsion value in different visual angles.

The handle (30) has a first abutment (31) formed on a distal side facing the electrical displayer (40), wherein the first abutment (31) is radially corresponding to an axis of the shank (10). A stick (32) perpendicularly extends from the first abutment (31) and multiple indentations (33) are circumferentially defined in the first abutment (31). The multiple indentations (33) define a circumferential angle being 180 degrees.

The electrical displayer (40) has a second abutment (41) formed on a distal side thereof and abutting against the first abutment (31). A curved groove (42) is laterally defined in the second abutment (41) for movably receiving the stick (32) such that the rotary range of the electrical displayer (40) is limited. The curved groove (42) defines a circumferential angle being 180 degrees. A hole (43) is laterally defined in the second abutment (41). A spring (431) and a steel ball (432) are sequentially received in the hole (43). The steel ball (432) is selectively engaged to a corresponding on the multiple indentations (33) such that the electrical displayer (40) can be rotated relative to the shank (10) step by step.

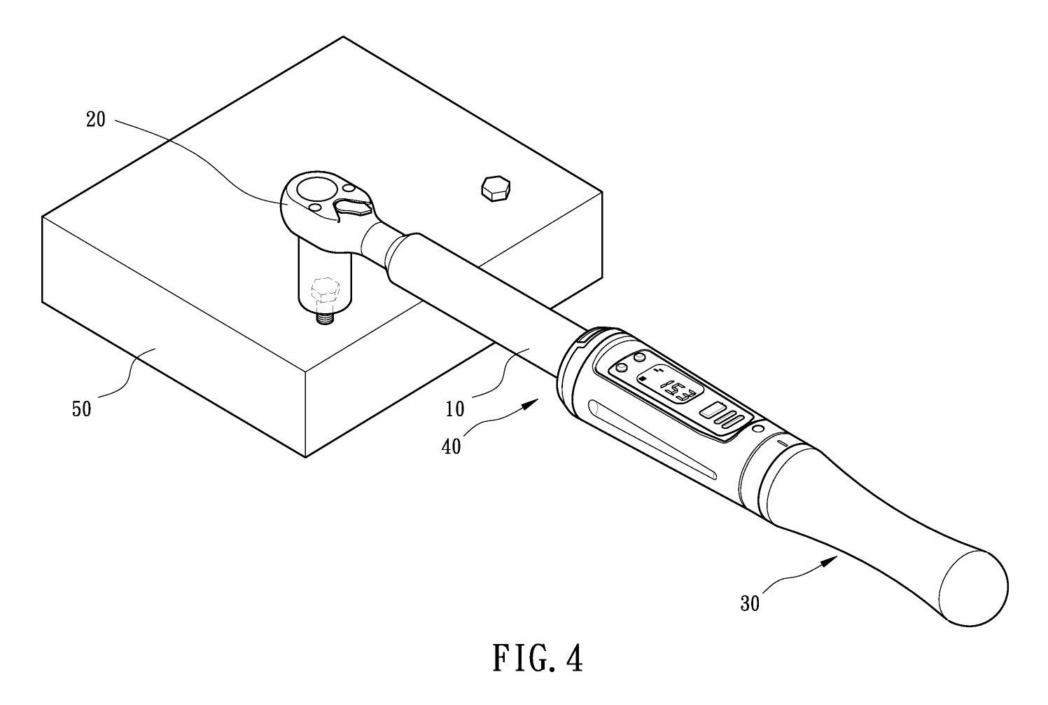

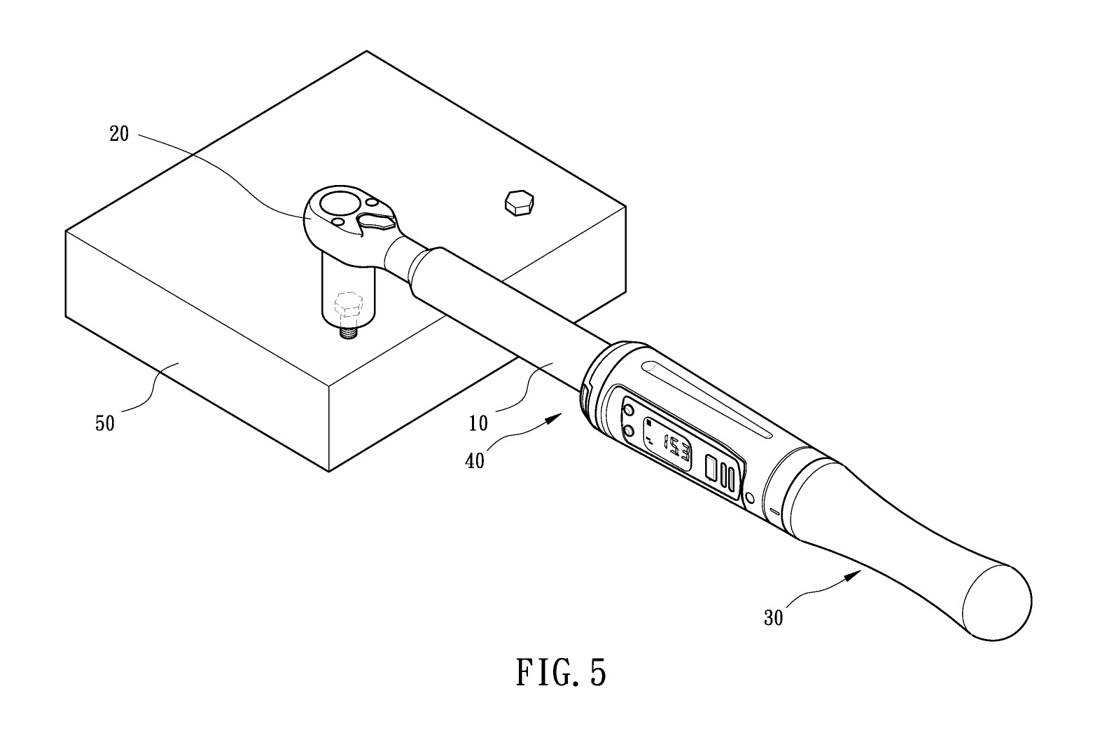

Reference to FIGS. 4-5, the screen (not numbered) of the electrical displayer (40) is parallel to the workpiece (50) when the work piece is lower than the horizontal visual angle of the operator, as shown in FIG. 4. The electrical displayer (40) is turned toward the user's eye's for easily read the operating torsion value when the horizontal height of the workpiece (50) approaches to the horizontal visual angle of the operator, as shown in FIG. 5. Consequently, the operator can easily and clearly read the operating torsion value in different operational angle due to the rotary electrical displayer (40).

Although the invention has been explained in relation to its preferred embodiment, it is to be understood that many other possible modifications and variations can be made without departing from the spirit and scope of the invention as hereinafter claimed.

What is claimed is:

1. An electrical torsion wrench comprising:
a shank;
an operational head mounted to one end of the shank;
a handle mounted to one end of the shank opposite to the operational head, the handle having a first abutment formed on a distal side and radially corresponding to an axis of the shank, a stick perpendicular extending from the first abutment; and
an electrical displayer rotatably sleeved on the shank and axially adjacent to the handle for the operator to easily and clear read the operating torsion value in different visual angles, the electrical displayer having a second abutment formed on a distal side thereof and abutting against the first abutment, a curved groove laterally defined in the second abutment for receiving the stick such that the rotary range of the electrical displayer is limited.

2. The electrical torsion wrench as claimed in claim 1, wherein the curved groove defines a circumferential angle being 180 degrees.

3. The electrical torsion wrench as claimed in claim 1, wherein the handle includes multiple indentations circumferentially defined in the first abutment, and the electrical torsion wrench has a hole laterally defined in the second abutment, a spring and a steel ball sequentially received in the hole and the steel ball selectively engaged to a corresponding one of the multiple indentations such that the electrical displayer is rotated relative the shank step by step.

4. The electrical torsion wrench as claimed in claim 3, wherein the multiple indentations define a circumferential angle being 180 degrees.

5. The electrical torsion wrench as claimed in claim 2, wherein the handle includes multiple indentations circumferentially defined in the first abutment, and the electrical torsion wrench has a hole laterally defined in the second abutment, a spring and a steel ball sequentially received in the hole and the steel ball selectively engaged to a corresponding one of the multiple indentations such that the electrical displayer is rotated relative the shank step by step.

6. The electrical torsion wrench as claimed in claim 5, wherein the multiple indentations define a circumferential angle being 180 degrees.
